(19) United States
(12) Patent Application Publication
(10) Pub. No.: US 2017/0175544 A1
(43) Pub. Date: Jun. 22, 2017

(54) COOLING CIRCUITS FOR A MULTI-WALL BLADE

(71) Applicant: General Electric Company, Schenectady, NY (US)

(72) Inventors: Aaron Ezekiel Smith, Montgomery, OH (US); David Wayne Weber, Simpsonville, SC (US)

(21) Appl. No.: 14/977,175

(22) Filed: Dec. 21, 2015

(51) Int. Cl. F01D 5/18

(52) U.S. Cl. CPC F01D 5/187; F05D 2220/30; F05D 2240/305; F05D 2240/306; F05D 2260/201; F05D 2260/202; F05D 2260/22141

(57) ABSTRACT

A cooling system for a multi-wall blade according to an embodiment includes: a primary cooling air feed for providing cooling air; and a feed splitter coupled to the primary cooling air feed for splitting the cooling air provided by the primary cooling air feed between a pressure side cooling circuit and a suction side cooling circuit.

### CROSS-REFERENCE TO RELATED APPLICATIONS

This application is related to co-pending U.S. application Ser. Nos. ______, GE docket numbers 282168-1, 282169-1, 282171-1, 282174-1, 283467-1, 283463-1, 283462-1, and 284160-1, all filed on ______.

### BACKGROUND OF THE INVENTION

The disclosure relates generally to turbine systems, and more particularly, to cooling circuits for a multi-wall blade.

Gas turbine systems are one example of turbomachines widely utilized in fields such as power generation. A conventional gas turbine system includes a compressor section, a combustor section, and a turbine section. During operation of a gas turbine system, various components in the system, such as turbine blades, are subjected to high temperature flows, which can cause the components to fail. Since higher temperature flows generally result in increased performance, efficiency, and power output of a gas turbine system, it is advantageous to cool the components that are subjected to high temperature flows to allow the gas turbine system to operate at increased temperatures.

Turbine blades typically contain an intricate maze of internal cooling channels. Cooling air provided by, for example, a compressor of a gas turbine system may be passed through the internal cooling channels to cool the turbine blades.

Multi-wall turbine blade cooling systems may include internal near wall cooling circuits. Such near wall cooling circuits may include, for example, near wall cooling channels adjacent the outside walls of a u all blade. The near wall cooling channels are typically small, requiring less cooling flow, while still. maintaining enough velocity for effective cooling to occur. Other, typically larger, low cooling effectiveness central channels of a multi-wall blade may be used as a. source of cooling air and may be used in one or more reuse circuits to collect and reroute “spent” cooling flow for redistribution to lower heat load regions of the multi-wall blade.

BRIEF DESCRIPTION OF THE INVENTION

A first aspect of the disclosure provides a cooling system for a multi-wall blade, including: a primary cooling air feed for providing cooling air; and a feed splitter coupled to the primary cooling air feed for splitting the cooling air provided by the primary cooling air feed between a pressure side cooling circuit and a suction side cooling circuit.

A second aspect of the disclosure provides a cooling system for a multi-wall blade, including: a primary cooling air feed for providing cooling air; and a feed splitter coupled to the primary cooling air feed for splitting the cooling air provided by the primary cooling air feed between a pressure side cooling circuit and a suction side cooling circuit, wherein the feed splitter includes a pressure side air feed for directing cooling air to the pressure side cooling circuit, a suction side air feed for directing cooling air to the suction side cooling circuit, and a rib disposed between the pressure side air feed and the suction side air feed; wherein the feed splitter divides the primary cooling air feed into the pressure side air feed and the suction side air feed along a line that is substantially perpendicular to a direction of rotation of the multi-wall blade.

A third aspect of the disclosure provides a multi-wall blade for a turbine, including: a pressure side cooling circuit; a suction side cooling circuit; a primary cooling air feed for providing cooling air; and a feed splitter coupled to the primary cooling air feed for splitting the cooling air provided by the primary cooling air feed between the pressure side cooling circuit and the suction side cooling circuit.

The illustrative aspects of the present disclosure solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure.

FIG. 1 shows a perspective view of a turbine bucket including a multi-wall blade according to various embodiments.

FIG. 2 is a cross-sectional view of the multi-wall blade of FIG. 1, taken along line X-X in FIG. 1 according to various embodiments.

FIG. 3 depicts a portion of the cross-sectional view of FIG. 2 showing a leading edge cooling circuit according to various embodiments.

FIG. 4 is a perspective view of the leading edge cooling circuit according to various embodiments.

FIG. 5 is a front view of a feed splitter for dividing a flow of cooling air into a pressure side air feed and a suction side air feed according to various embodiments.

FIG. 6 is a side view of a feed splitter for dividing a flow of cooling air into a pressure side feed and a suction side air feed according to various embodiments.

FIG. 7 is a cross-sectional view of the feed splitter of FIG. 5, taken along line Y-Y in FIG. 5 according to various embodiments.

FIG. 8 is a cross-sectional view of the feed splitter of FIG. 6, taken along line Z-Z in FIG. 6 according to various embodiments.

FIG. 9 is a schematic diagram of a gas turbine system according to various embodiments.

It is noted that the drawing of the disclosure is not to scale. The drawing is intended to depict only typical aspects of the disclosure, and therefore should not be considered as limiting the scope of the disclosure. In the drawing, like numbering represents like elements between the drawings.

### DETAILED DESCRIPTION OF THE INVENTION

As indicated above, the disclosure relates generally to turbine systems, and more particularly, to cooling circuits for cooling a multi-wall blade.

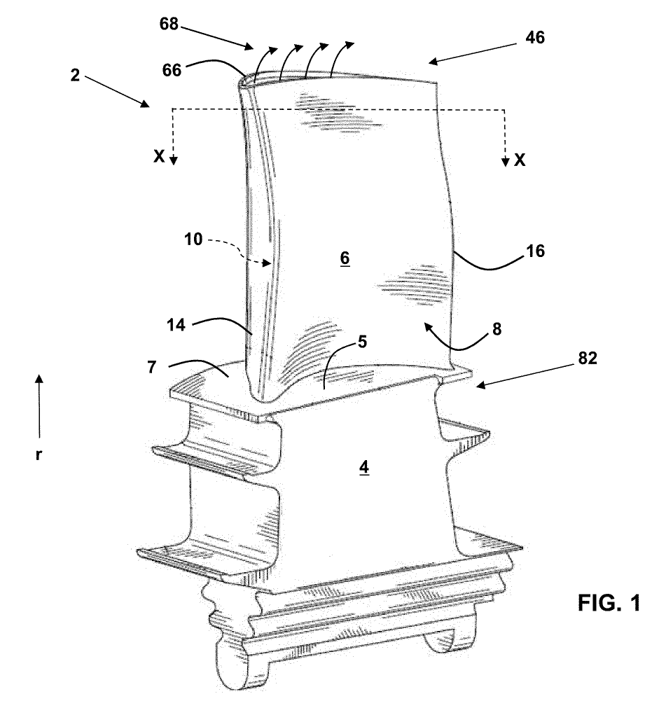

In the Figures (see, e.g., FIG. 9), the “A” axis represents an axial orientation. As used herein, the terms “axial” and/or “axially” refer to the relative position/direction of objects along axis A, which is substantially parallel with the axis of rotation of the turbomachine (in particular, the rotor section). As further used herein, the terms “radial” and/or “radially” refer to the relative position/direction of objects along an axis “r” (see, e.g., FIG. 1), which is substantially perpendicular with axis A and intersects axis A at only one location.

Turning to FIG. 1, a perspective view of a turbine bucket 2 is shown. The turbine bucket 2 includes a shank 4 and a multi-wall blade 6 coupled to and extending radially outward from the shank 4. The multi-wall blade 6 includes a pressure side 8, an opposed suction side 10, and a tip area 38. The multi-wall blade 6 further includes a leading edge 14 between the pressure side 8 and the suction side 10, as well as a trailing edge 16 between the pressure side 8 and the suction side 10 on a side opposing the leading edge 14. The multi-wall blade 6 extends radially away from a pressure side platform 5 and a suction side platform 7.

The shank 4 and multi-wall blade 6 may each be formed of one or more metals (e.g., steel, alloys of steel, etc.) and may be formed (e.g., cast, forged or otherwise machined) according to conventional approaches. The shank 4 and multi-wall blade 6 may be integrally formed (e.g., cast, forged, three-dimensionally printed, etc.), or may be formed as separate components which are subsequently joined (e.g., via welding, brazing, bonding or other coupling mechanism).

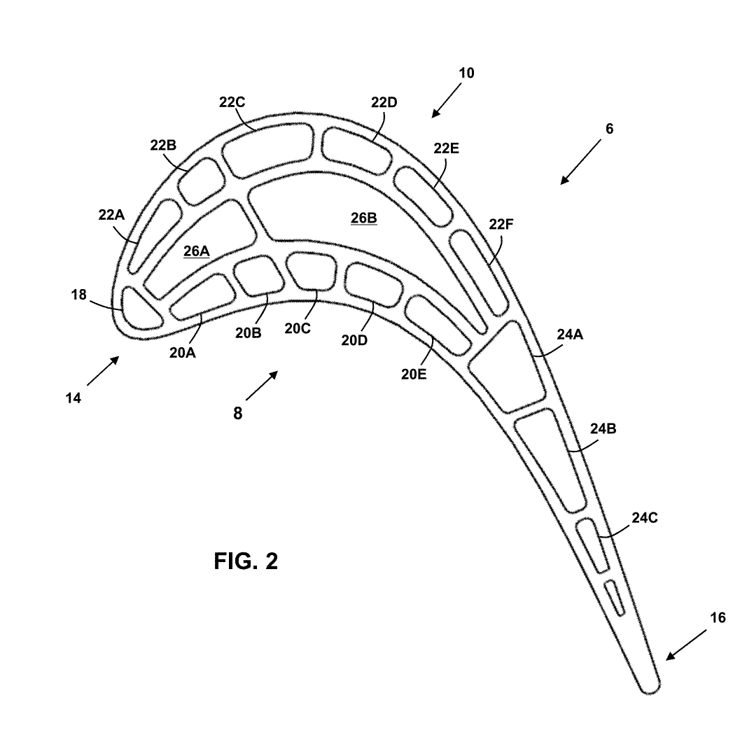

FIG. 2 depicts a cross-sectional view of the multi-wall blade 6 taken along line X-X of FIG. 1. As shown, the multi-wall blade 6 may include a plurality of internal cavities. In embodiments, the multi-wall blade 6 includes a leading edge cavity 18, a plurality of pressure side (near wall) cavities 20A-20E, a plurality of suction side (near wall) cavities 22A-22F, a plurality of trailing edge cavities 24A-24C, and a plurality of central cavities 26A, 26B. The number of cavities 18, 20, 22, 24, 26 within the multi-wall blade 6 may vary, of course, depending upon for example, the specific configuration, size, intended use, etc., of the multi-wall blade 6. To this extent, the number of cavities 18, 20, 22, 24, 26 shown in the embodiments disclosed herein is not meant to be limiting. According to embodiments, various cooling circuits can be provided using different combinations of the cavities 18, 20, 22, 24, 26.

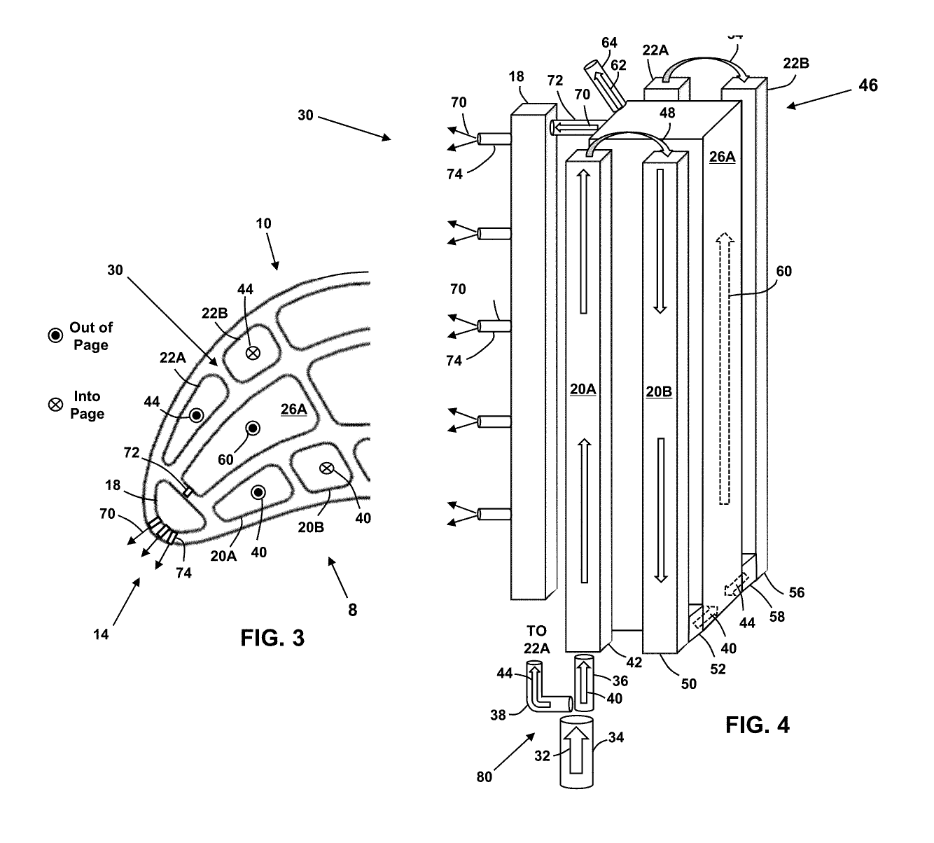

An embodiment including an leading edge cooling circuit 30 is depicted in FIGS. 3 and 4. As the name indicates, the leading edge cooling circuit 30 is located adjacent the leading edge 14 of the multi-wall blade 6, between the pressure side 8 and suction side 10 of the multi-wall blade 6.

Referring simultaneously to FIGS. 3 and 4, a supply of cooling air 32, generated for example by a compressor 104 of a gas turbine system 102 (FIG. 9), is fed through the shank 4 (FIG. 1) to the leading edge cooling circuit 30 via a primary cooling air feed 34. According to embodiments, the primary cooling air feed 34 includes a feed splitter 80 that is configured to divide the cooling air 32 between at least two air feeds to direct cooling air to a plurality of different cooling circuits within the leading edge cooling circuit 30.

As depicted schematically in FIG. 4, the primary cooling air feed 34 may be divided via the feed splitter 80 into a pressure side air feed 36 and a suction side air feed 38. The pressure side air feed 36 directs a first portion 40 of the cooling air 32 to a base 42 of the pressure side cavity 20A. The pressure side cavity 20A forms the first leg of an aft-flowing two-pass serpentine cooling circuit adjacent the pressure side 8 of the multi-wall blade 6. The suction side air feed 38 directs a second portion 44 of the cooling air 32 to a base (not shown) of the suction side cavity 22A. The suction side cavity 22A forms the first leg of an aft-flowing two-pass serpentine cooling circuit adjacent the suction side 10 of the multi-wall blade 6. Such a split feed configuration may be used, for example, in the case where there is not enough room within the components of the turbine bucket 2 for multiple primary cooling air feeds.

As depicted in FIGS. 3 and 4 together with FIG. 1, the first portion 40 of the cooling air 32 flows radially outward through the pressure side cavity 20A toward a tip area 46 of the multi-wall blade 6. A turn 48 redirects the first portion 40 of the cooling air 32 from the pressure side cavity 20A into the pressure side cavity 20B. The pressure side cavity 20B forms the second leg of the two-pass serpentine cooling circuit adjacent the pressure side 8 of the multi-wall blade 6. The first portion 40 of the cooling air 32 flows radially inward through the pressure side cavity 20B toward a base 50 of the pressure side cavity 20B, and then flows through a passage 52 into the central cavity 26A.

In a corresponding manner, the second portion 44 of the cooling air 32 flows radially outward through the suction side cavity 22A toward the tip area 46 of the multi-wall blade 6. A turn 54 redirects the second portion 44 of the cooling air 32 from the suction side cavity 22A into the suction side cavity 22B. The suction side cavity 22B forms the second leg of the two-pass serpentine cooling circuit adjacent the suction side 10 of the multi-wall blade 6. The second portion 44 of the cooling air 32 flows radially inward through the suction side cavity 22B toward a base 56 of the suction side cavity 22B, and then flows through a passage 58 into the central cavity 26A.

After passing into the central cavity 26A, the first and second portions 40, 44 of the cooling air 32 combine into a single flow of cooling air 60, which flows radially outward through the central cavity 26A toward the tip area 46 of the multi-wall blade 6. A first portion 62 of the cooling air 60 is directed by at least one tip film channel 64 from the central cavity 26A to the tip 66 (FIG. 1) of the multi-wall blade 6. The first portion 62 of the cooling air 50 is exhausted from the tip 66 of the multi-wall blade 6 as tip film 68 to provide tip film cooling.

A second portion 70 of the cooling air 60 is directed by at least one impingement hole 72 from the central cavity 26A to the leading edge cavity 18. The second portion 70 of the cooling air 60 flows out of the leading edge cavity 18 to the leading edge 14 of the multi-wall blade 6 via at least one film hole 74 to provide impingement cooling of the leading edge 14.

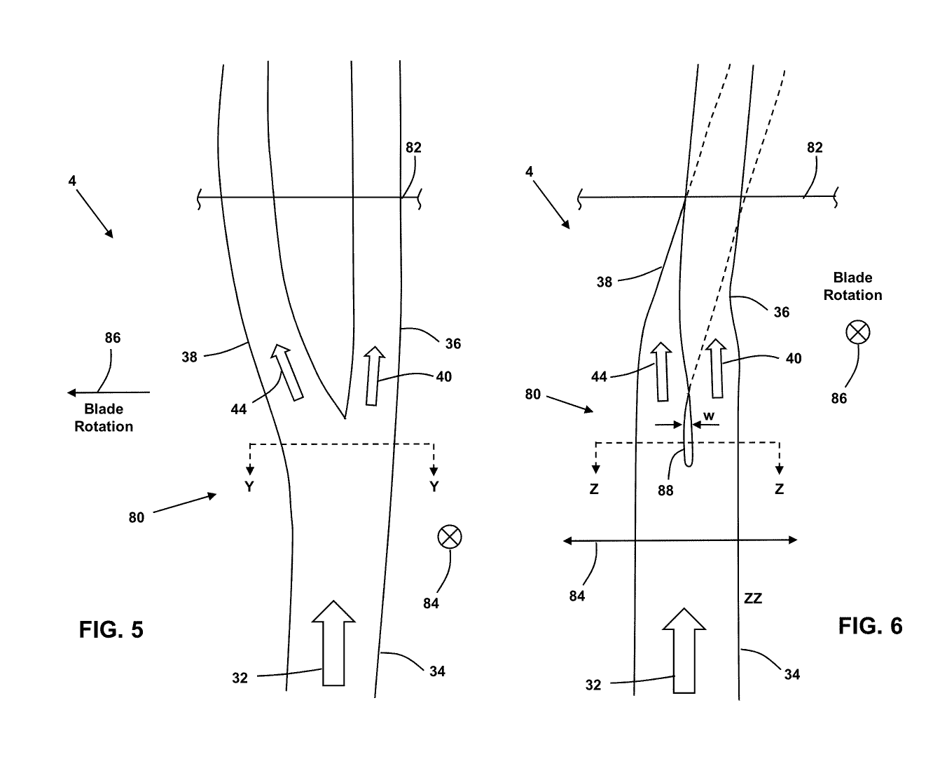

A front view of the feed splitter 80 for dividing the cooling air 32 flowing through the primary cooling air feed 34 between the pressure side air feed 36 and the suction side air feed 38 is depicted in FIG. 5. The front view is taken looking from the leading edge 14 of the multi-wall blade 6 toward the central cavity 26A. A side view of the feed splitter 80 taken from the pressure side 8 of the multi-wall blade 6 is depicted in FIG. 6. As shown, the feed splitter 80 may be disposed within the shank 4 below a root area 82 of the multi-wall blade 6. According to embodiments, the feed splitter 80 may be positioned at or near a section (e.g., a relatively wide or widest section) of the primary cooling air feed 34 having a low Mach number to minimize contraction of the flow field.

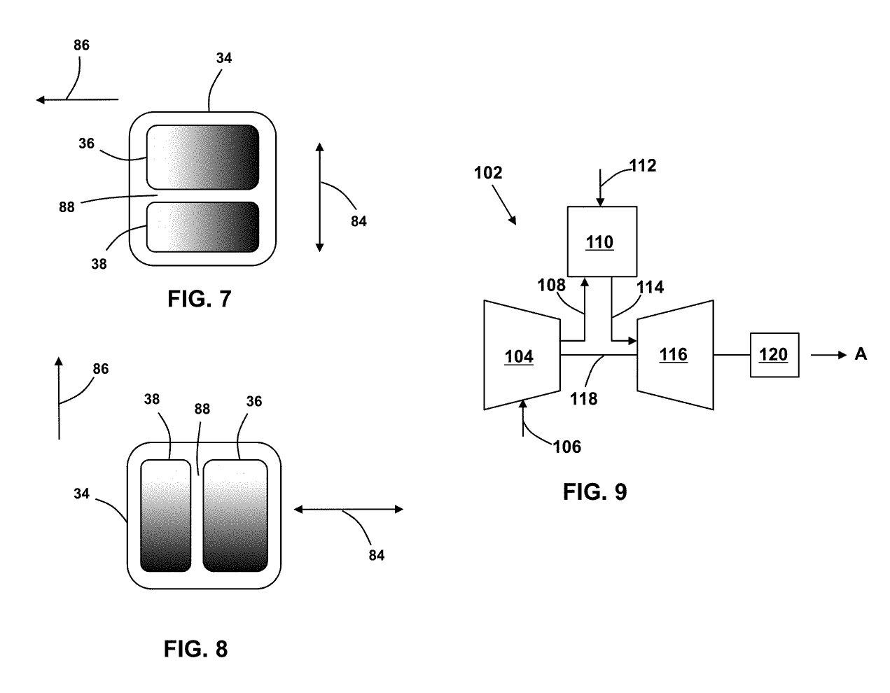

According to embodiments, the feed splitter 80 divides the primary cooling air feed 34 into the pressure side air feed 36 and the suction side air feed 38. The feed splitter 80 is configured to compensate for Coriolis forces generated during rotation of the multi-wall blade 6 and to ensure that a proper amount of cooling air is directed into both the pressure and suction side air feeds 36, 38 during rotation of the multi-wall blade 6. For example, as can be seen most readily in FIGS. 6-8, the feed splitter 80 divides the primary cooling air feed 34 along a line 84 that is substantially perpendicular to the direction of rotation 86 of the multi-wall blade 6. In this way, as depicted in FIGS. 7 and 8, Coriolis forces generate a substantially equal pressure gradient in both the pressure side air feed 36 and the suction side air feed 38 in the direction of rotation 86 of the multi-wall blade 6.

As shown in FIGS. 6-8, a rib 88 may be located between the pressure side air feed 36 and suction side air feed 38. In embodiments, the rib 88 is made as thin as possible to reduce pressure flow losses as the cooling air 32 flows from the primary air feed 34 around the sides of the rib 88 into the pressure side air feed 36 and suction side air feed 38. For example, the rib 88 may have a width w (FIG. 6) of about 0.04 inches to about 0.1 inches.

The feed splitter 80 has been described herein in conjunction with a leading edge cooling circuit 30 of a multi-wall blade 6. However, this is not meant to be limiting. The feed splitter 80 may be used in conjunction with any type of cooling circuit in a multi-wall blade in which an air feed is split into a plurality of sub-feeds. Further, the feed splitter 80 may be used in rotating structures other than a multi-wall blade to divide a fluid feed into a plurality of sub-feeds.

FIG. 9 shows a schematic view of gas turbomachine 102 as may be used herein. The gas turbomachine 102 may include a compressor 104. The compressor 104 compresses an incoming flow of air 106. The compressor 104 delivers a flow of compressed air 108 to a combustor 110. The combustor 110 mixes the flow of compressed air 108 with a pressurized flow of fuel 112 and ignites the mixture to create a flow of combustion gases 114. Although only a single combustor 110 is shown, the gas turbomachine 102 may include any number of combustors 110. The flow of combustion gases 114 is in turn delivered to a turbine 116, which typically includes a plurality of turbine buckets 2 (FIG. 1). The flow of combustion gases 114 drives the turbine 116 to produce mechanical work. The mechanical work produced in the turbine 116 drives the compressor 104 via a shaft 118, and may be used to drive an external load 120, such as an electrical generator and/or the like.

In various embodiments, components described as being “coupled” to one another can be joined along one or more interfaces. In some embodiments, these interfaces can include junctions between distinct components, and in other cases, these interfaces can include a solidly and/or integrally formed interconnection. That is, in some cases, components that are “coupled” to one another can be simultaneously formed to define a single continuous member. However, in other embodiments, these coupled components can be formed as separate members and be subsequently joined through known processes (e.g., fastening, ultrasonic welding, bonding).

When an element or layer is referred to as being “on”, “engaged to”, “connected to” or “coupled to” another element, it may be directly on, engaged, connected or coupled to the other element, or intervening elements may be present. In contrast, when an element is referred to as being “directly on,” “directly engaged to”, “directly connected to” or “directly coupled to” another element, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A cooling system for a multi-wall blade, comprising:
a primary cooling air feed for providing cooling air; and
a feed splitter coupled to the primary cooling air feed for splitting the cooling air provided by the primary cooling air feed between a pressure side cooling circuit and a suction side cooling circuit.

2. The cooling system of claim 1, wherein the feed splitter includes a pressure side air feed for directing cooling air to the pressure side cooling circuit, and wherein the feed splitter includes a suction side air feed for directing cooling air to the suction side cooling circuit.

3. The cooling system of claim 2, wherein the feed splitter divides the primary cooling air feed into the pressure side air feed and the suction side air feed along a line that is substantially perpendicular to a direction of rotation of the multi-wall blade.

4. The cooling system of claim 2, wherein a substantially equal pressure gradient is generated in the pressure side air feed and the suction side air feed.

5. The cooling system of claim 2, wherein the feed splitter includes a rib disposed between the pressure side air feed and the suction side air feed.

6. The cooling system of claim 5, wherein the rib is sized to minimize pressure flow losses as the cooling air flows from the primary air feed into the first and second air feeds.

7. The cooling system of claim 6, wherein the rib has a width of about 0.04 inches to about 0.01 inches.

8. The cooling system of claim 1, wherein the primary cooling air feed and the feed splitter are disposed within a shank of the multi-wall blade.

9. The cooling system of claim 1, wherein the primary cooling air feed and the feed splitter are disposed radially inward of a root area of the multi-wall blade.

10. The cooling system of claim 1, wherein the feed splitter is positioned at a low Mach number section of the primary cooling air feed.

11. A cooling system for a multi-wall blade, comprising:
a primary cooling air feed for providing cooling air; and
a feed splitter coupled to the primary cooling air feed for splitting the cooling air provided by the primary cooling air feed between a pressure side cooling circuit and a suction side cooling circuit, wherein the feed splitter includes a pressure side air feed for directing cooling air to the pressure side cooling circuit, a suction side air feed for directing cooling air to the suction side cooling circuit, and a rib disposed between the pressure side air feed and the suction side air feed;
wherein the feed splitter divides the primary cooling air feed into the pressure side air feed and the suction side air feed along a line that is substantially perpendicular to a direction of rotation of the multi-wall blade.

12. The cooling system of claim 11, wherein a substantially equal pressure gradient is generated in the pressure side air feed and the suction side air feed.

13. The cooling system of claim 11, wherein the rib has a width of about 0.04 inches to about 0.01 inches.

14. The cooling system of claim 11, wherein the feed splitter is positioned at a low Mach number section of the primary cooling air feed.

15. A multi-wall blade for a turbine, including:
a pressure side cooling circuit;
a suction side cooling circuit;
a primary cooling air feed for providing cooling air; and
a feed splitter coupled to the primary cooling air feed for splitting the cooling air provided by the primary cooling air feed between the pressure side cooling circuit and the suction side cooling circuit.

16. The multi-wall blade of claim 15, wherein the feed splitter includes a pressure side air feed for directing cooling air to the pressure side cooling circuit, and wherein the feed splitter includes a suction side air feed for directing cooling air to the suction side cooling circuit.

17. The multi-wall blade of claim 16, wherein the feed splitter divides the primary cooling air feed into the pressure side air feed and the suction side air feed along a line that is substantially perpendicular to a direction of rotation of the multi-wall blade.

18. The multi-wall blade of claim 16, wherein a substantially equal pressure gradient is generated in the pressure side air feed and the suction side air feed.

19. The multi-wall blade of claim 16, wherein the feed splitter includes a rib disposed between the pressure side air feed and the suction side air feed.

20. The multi-wall blade of claim 19, wherein the rib has a width of about 0.04 inches to about 0.01 inches.
